(19) United States
(12) Patent Application Publication
(10) Pub. No.: US 2015/0295729 A1
(43) Pub. Date: Oct. 15, 2015

(54) HARDWARE ACCELERATOR FOR TUNNEL PROCESSING

(71) Applicants: LOKESH BEVINAMARAD, Hubli (IN); Mallikarjun Mudigonda, Hyderabad (IN)

(72) Inventors: LOKESH BEVINAMARAD, Hubli (IN); Mallikarjun Mudigonda, Hyderabad (IN)

(21) Appl. No.: 14/248,363

(22) Filed: Apr. 9, 2014

(51) Int. Cl. H04L 12/46

(52) U.S. Cl. CPC H04L 12/4633

(57) ABSTRACT

A node for a communications system has a hardware accelerator that supports communications using any of a variety of different, UDP-based, tunnel protocols, and a tunnel software application configures the hardware accelerator to operate for any of the supported tunnel protocols. The hardware accelerator works for any UDP-based, non-cryptographic tunnel protocol. The tunnel software application provides the hardware accelerator with particular instances of generic outbound and inbound profiles that define the header fields for particular tunnel protocols. The hardware accelerator uses those profiles respectively to encapsulate and decapsulate outbound and inbound packets. In this way, tunnel processing is accelerated without having to provide different hardware accelerators for different tunnel protocols.

### BACKGROUND OF THE INVENTION

The present invention relates generally to communications over computer networks, and more particularly to a generic hardware accelerator for tunnel processing.

Tunnel processing refers to the encapsulation of packetized data to be transmitted from a source node through an intermediate communications network to a destination node and/or the subsequent decapsulation of the received encapsulated packet at the destination node. Encapsulation involves pre-pending one or more outer, transport (e.g., IP/UDP) headers followed by an inner, tunnel protocol header to an outbound packet, while decapsulation involves removing the transport and tunnel protocol headers from an encapsulated, inbound packet. There are a wide variety of different tunnel protocols including VxLAN, GRE, GTP-u V1, L2TP, and other so-called L3 tunnel protocols.

Tunnel processing currently is implemented either entirely within a tunnel software application or by a tunnel software application assisted by a custom hardware accelerator specifically designed for the relevant tunnel protocol. While a custom hardware accelerator enables tunnel processing to be performed faster than a corresponding software-only implementation, the custom hardware accelerator is limited to the specific tunnel protocol for which it is designed. Conventional nodes must be provisioned with different custom hardware accelerators in order to support different communications sessions using different tunnel protocols.

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale. For example, the thicknesses of layers and regions may be exaggerated for clarity.

FIG. 1 shows a simplified block diagram of a communications system comprising first and second nodes communicating over an intermediate communications network that conforms to a specific tunnel protocol;

FIG. 2 shows a flow diagram of processing performed within a node of FIG. 1 to configure its hardware accelerator to process packets according to a particular tunnel protocol selected from the variety of different tunnel protocols supported by the hardware accelerator;

FIG. 3 shows a flow diagram of the processing implemented by the hardware accelerators of FIG. 1 in step 206 of FIG. 2;

FIG. 4 shows a flow diagram of the encapsulation processing implemented by the hardware accelerator of node 110 of FIG. 1 for an outbound packet of data to be transmitted over the communications network to node 130;

FIG. 5 shows a flow diagram of the decapsulation processing implemented by the hardware accelerator of node 130 of FIG. 1 for the inbound packet of data encapsulated according to the encapsulation processing of FIG. 4 and transmitted over the communications network from node 110;

FIG. 6 represents the generic format for the outbound profiles for the different tunnel protocols supported by the hardware accelerators of FIG. 1 for outbound packets having outer IPv4 headers;

FIGS. 7-9 are logic flow diagrams describing the meanings of the Type, Length, Offset, Bit Position, and Value sub-fields of FIG. 6 when for different values of the Action sub-field of FIG. 6;

FIG. 10 represents the generic format for the outbound profiles for the different tunnel protocols supported by the hardware accelerators of FIG. 1 for outbound packets having outer IPv6 headers;

FIG. 11 represents the generic format for the inbound profiles for the different tunnel protocols supported by the hardware accelerators of FIG. 1 for inbound packets having outer IPv4 headers;

FIG. 12 is a logic flow diagram describing the meanings of the Type, Length, Offset, Bit Position, and Value sub-fields of each Validation field of FIG. 11;

FIG. 13 represents the generic format for the inbound profiles for the different tunnel protocols supported by the hardware accelerators of FIG. 1 for inbound packets having outer IPv6 headers;

FIG. 14 shows a representation of the format of the tunnel protocol header according to the VX-LAN tunnel protocol;

FIG. 15 shows a representation of the outbound profile generated by the tunnel software application of node 110 for an exemplary VX-LAN communications session as a particular instance of the generic outbound profile of FIG. 6;

FIG. 16 shows a representation of the inbound profile generated by the tunnel software application of node 130 for the same exemplary VX-LAN communications session of FIG. 15 as a particular instance of the generic inbound profile of FIG. 11;

FIG. 17 shows a representation of the format of the tunnel protocol header according to the GTP-u V1 tunnel protocol;

FIG. 18 shows a representation of the outbound profile generated by the tunnel software application of node 110 for an exemplary GTP-u V1 communications session as a particular instance of the generic outbound format of FIG. 6; and

FIG. 19 shows a representation of the inbound profile generated by the tunnel software application of node 130 for the exemplary GTP-u V1 communications session of FIG. 18 as a particular instance of the generic inbound format of FIG. 11.

### DETAILED DESCRIPTION

Detailed illustrative embodiments of the present invention are disclosed herein. However, specific structural and functional details disclosed herein are merely representative for purposes of describing example embodiments of the present invention. The present invention may be embodied in many alternate forms and should not be construed as limited to only the embodiments set forth herein. Further, the terminology used herein is for the purpose of describing particular embodiments only and is not intended to be limiting of example embodiments of the invention.

As used herein, the singular forms “a,” “an,” and “the,” are intended to include the plural forms as well, unless the context clearly indicates otherwise. It further will be understood that the terms “comprises,” “comprising,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

In one embodiment, the present invention provides a first node comprising a hardware accelerator and a tunnel software application. The hardware accelerator is configurable to support any of a plurality of different tunnel protocols. The tunnel software application is programmed to configure the hardware accelerator to support communications sessions for any of the plurality of tunnel protocols using specific outbound and inbound profiles corresponding to generic outbound and inbound profiles that respectively define encapsulation and decapsulation processing implemented by the hardware accelerator for a specific communications session.

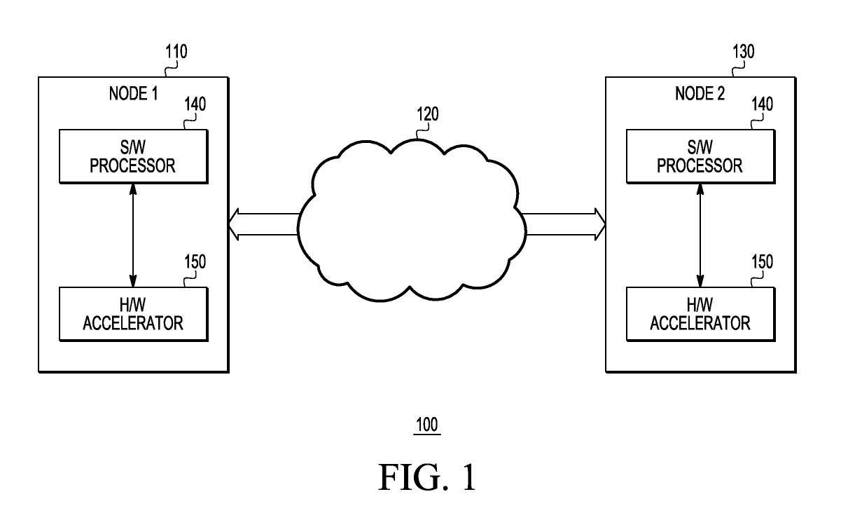

FIG. 1 is a simplified block diagram of a communications system 100 comprising first and second nodes 110 and 130 communicating over an intermediate communications network 120 that conforms to a specific tunnel protocol. As shown in FIG. 1, each node has a general-purpose, programmable, tunnel software application 140 and a generic hardware accelerator 150 for tunnel processing. Although hardware accelerator 150 is built using application-specific integrated circuit (ASIC) logic, it is generic in that it can selectively support encapsulation and decapsulation processing for a variety of different tunnel protocols. As such, each node 110, 130 can perform tunnel processing for different tunnel protocols faster than a software-only implementation while needing only a single hardware accelerator for that variety of different tunnel protocols.

Depending on the particular implementation, within each node, tunnel software application 140 and hardware accelerator 150 may be discrete components or they may be part of a single, integrated, system-on-chip (SOC) component.

In a typical implementation, each node will be able to transmit and receive encapsulated packets. As such, each node will have the ability to encapsulate outbound packets as well as decapsulate inbound packets. For those possible implementations in which some nodes might only transmit or only receive encapsulated packets, those nodes might be provisioned with the ability only to encapsulate packets or only to decapsulate packets, as appropriate.

Note that, in a real-world implementation, system 100 may have one or more additional nodes (not shown in FIG. 1) that can communicate over communications network 120. In addition, each node in system 100 may also be able to communicate (potentially concurrently) over one or more additional communications networks (not shown in FIG. 1) that may conform to other tunnel protocols. As such, it may be desirable for each node in system 100 that is connected to communicate over multiple communications networks having different tunnel protocols to be provisioned with its own instance of hardware accelerator 150.

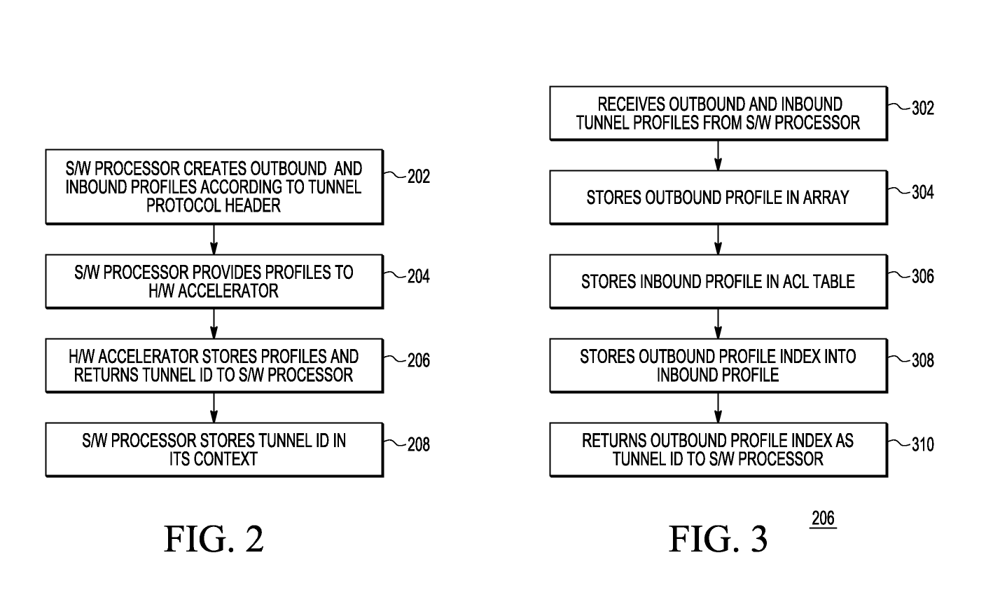

FIG. 2 is a flow diagram of processing performed within a node, such as nodes 110 and 130 of FIG. 1, to configure its hardware accelerator 150 to process packets according to a particular tunnel protocol selected from the variety of different tunnel protocols supported by the hardware accelerator. The proposed solution works for any User Datagram Protocol (UDP)-based, non-cryptographic tunnel protocol. The hardware accelerator, which is able to interpret and execute proposed tunnel profiles, does not need to have any tunnel-protocol-specific knowledge. As such, hardware implementers need not put tunnel-protocol-specific ASIC logic in the hardware accelerators. Just the hardware logic/ability of interpreting and executing tunnel profiles is sufficient for encapsulation and decapsulation of any supported tunnel protocol. The processing of FIG. 2 is implemented after tunnel software application 140 has been programmed (e.g., using conventional techniques) for the particular tunnel protocol.

In step 202, tunnel software application 140 creates outbound and inbound profiles according to the particular tunnel protocol header. As described further below, each supported tunnel protocol is represented by an outbound profile and an inbound profile that define the features of the tunnel protocol header. The outbound profile enables hardware accelerator 150 to encapsulate outbound packets, according to the corresponding tunnel protocol, while the inbound profile enables the hardware accelerator to decapsulate inbound packets, according to that same tunnel protocol.

In step 204, tunnel software application 140 provides those outbound and inbound profiles to hardware accelerator 150. In step 206, hardware accelerator 150 stores the profiles, assigns a unique Tunnel ID (identification) number to those profiles, and transmits that unique Tunnel ID number to tunnel software application 140. In step 208, tunnel software application 140 stores the Tunnel ID for the corresponding tunnel protocol.

FIG. 3 is a flow diagram of the processing implemented by hardware accelerator 150 in step 206 of FIG. 2. In step 302, the hardware accelerator receives the outbound and inbound tunnel profiles from tunnel software application 140. In step 304, the hardware accelerator stores the outbound profile in an array, which is an indexed list where a desired item can be located by indexing with a given parameter (in this case, with the Tunnel ID). In step 306, the hardware accelerator stores the inbound profile in an inbound tunnel profile database. For inbound processing, the hardware accelerator finds the matching Tunnel ID based on incoming packet parameters. Hence, the hardware accelerator uses table-searching methods, which include matching multiple packet parameters. The hardware accelerator searches the 5-tuple-based inbound tunnel profile database using 5 tuples of the incoming tunneled packet. Some of the tuples in the inbound tunnel profile database can be wildcards. In step 308, the hardware accelerator sets the Tunnel ID to be the array index value of the outbound profile and stores the Tunnel ID into the inbound profile in the inbound tunnel profile database. In step 310, the hardware accelerator transmits the Tunnel ID to tunnel software application 140.

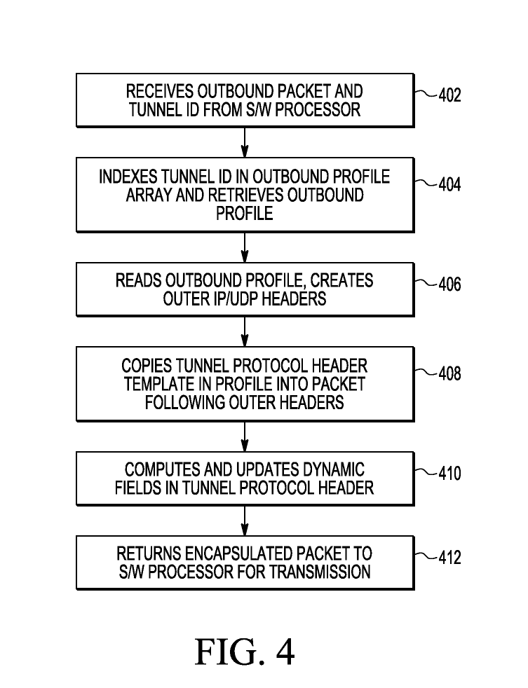

FIG. 4 is a flow diagram of the encapsulation processing implemented by hardware accelerator 150 of node 110 of FIG. 1 for an outbound packet of data to be transmitted over communications network 120 to node 130. The processing of FIG. 4 is implemented after tunnel software application 140 of node 110 has determined (e.g., using conventional techniques) that the outbound packet is to be encapsulated using a particular tunnel protocol for a particular communications session identified by a particular Tunnel ID value. Note that analogous processing is implemented by hardware accelerator 150 of node 130 for outbound packets transmitted to node 110.

In step 402, the hardware accelerator receives, from the tunnel software application, the outbound packet along with the appropriate Tunnel ID value. In step 404, the hardware accelerator indexes the Tunnel ID in the outbound profile array and retrieves the corresponding outbound profile. In step 406, the hardware accelerator reads the retrieved outbound profile and creates corresponding outer, transport (e.g., IP/UDP (Internet Protocol/User Datagram Protocol)) headers.

The tunnel protocol header may contain fixed and dynamic fields. Hence, the outbound tunnel profile should provide a way to create both fixed and dynamic fields. The way dynamic fields differ from the fixed fields is that the values in dynamic fields can change for each packet in a tunnel stream, whereas the values in fixed fields do not change and remain constant for all packets in the tunnel stream.

The outbound tunnel profile contains a pre-created tunnel protocol header template with fixed tunnel header field values. This pre-created template can be used to specify fixed header fields. The creation of dynamic fields is guided by the information in the Dynamic Field section of the outbound profile. Each Dynamic Field describes how to create one dynamic tunnel header field at a given offset starting from the start of the tunnel protocol header (as mentioned in the Offset subfield). Based on whether the action sub-field is Length/Sequence/Software, the hardware accelerator interprets the other subfields in the dynamic field and computes the value for a given packet for that dynamic field.

In step 408, the hardware accelerator copies the tunnel protocol header template in the retrieved outbound profile into the packet following the outer, transport headers. In step 410, the hardware accelerator computes and updates the dynamic fields (if any) in the tunnel protocol header. In step 412, the hardware accelerator returns the resulting encapsulated packet to the tunnel software application for transmission (e.g., using conventional techniques) to the other node over communications network 120

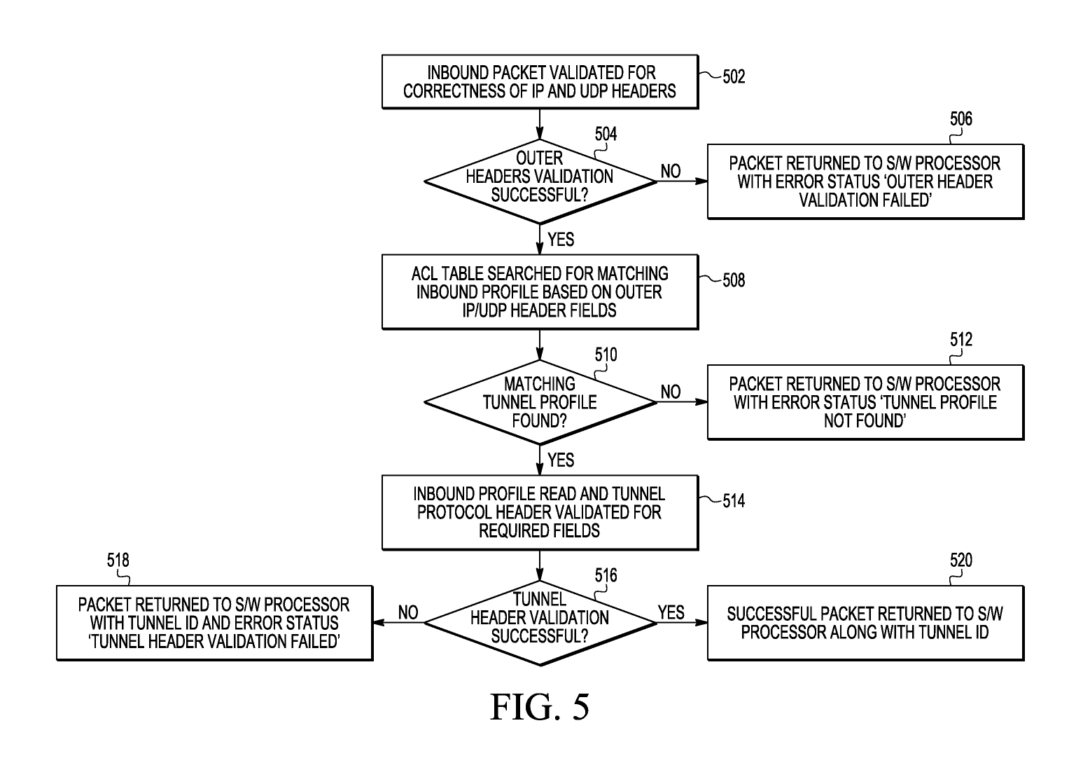

FIG. 5 is a flow diagram of the decapsulation processing implemented by hardware accelerator 150 of node 130 of FIG. 1 for the encapsulated inbound packet of data generated by the encapsulation processing of FIG. 4 and transmitted over communications network 120 from node 110. The processing of FIG. 5 is implemented after tunnel software application 140 of node 130 has provided (e.g., using conventional techniques) the inbound packet to the hardware accelerator. Note that analogous processing is implemented by hardware accelerator 150 of node 110 for inbound packets received from node 120.

In step 502, the hardware accelerator attempts to validate the inbound packet for correctness of its outer, transport headers. In particular, the hardware accelerator validates outer IP and UDP headers, for example, by validating their fields such as checksum, length, etc. Note that the hardware accelerator possesses the built-in capability to create and validate outer IP/UDP headers based on the information given in the tunnel profiles. If the outer, transport headers are not successfully validated (step 504), then, in step 506, the hardware accelerator returns the inbound packet to the tunnel software application with an appropriate error status (e.g., “Outer Header Validation Failed”). The tunnel software application will then handle the error status appropriately (e.g., using conventional techniques). If the outer, transport headers (i.e., IP/UDP headers) are successfully validated (step 504), then, in step 508, the hardware accelerator searches the inbound tunnel profile database for the matching inbound profile based on the outer, transport header fields. The searching is based on 5 tuples of the network packet with table entries that can contain wildcards. Conventional methods used for searching access control lists can be used here.

Inbound tunnel packet processing involves validating the outer IP/UDP headers, searching for the matching inbound tunnel profile, and then validating the tunnel protocol header fields. The inbound tunnel profiles can be searched based on the 5-tuple fields of the outer IP/UDP headers. The inbound tunnel profiles can have wildcards for some of the 5-tuple fields. A search similar to an ACL (Access Control List) search can be employed. Hardware blocks like TCAM (Ternary Content Addressable Memory) can be used to accelerate this search.

The validation of tunnel protocol fields is guided by the information in the validation section of the inbound tunnel profile. Each Validation field describes one tunnel header field that needs to be validated in the inbound packet. The Validation field describes what value is to be expected at the given offset in the tunnel protocol header of the inbound packet. If the value described by the Validation field is not found at the given offset in the inbound packet, then the validation of that tunnel header field and tunnel header as a whole are assumed to be failed. On the other hand, if the value described by the Validation field matches the value contained in the tunnel header at the given offset, then the validation of that field is assumed to be successful. For a tunnel header to be successfully validated, values described by all the Validation fields in the inbound profile must match the values in the inbound tunnel header at respective offsets.

If a matching inbound profile is not found (step 510), then, in step 512, the hardware accelerator returns the inbound packet to the tunnel software application with an appropriate error status (e.g., “Inbound Profile Not Found”). Here, too, the tunnel software application will then handle the error status appropriately (e.g., using conventional techniques). If a matching inbound profile is found (step 510), then, in step 514, the hardware accelerator reads the inbound profile and validates the inner, tunnel protocol header for one or more required fields.

If the tunnel protocol header is not successfully validated (step 516), then, in step 518, the hardware accelerator returns the inbound packet to the tunnel software application with an appropriate error status (e.g., “Tunnel Header Validation Failed”). Here, too, the tunnel software application will then handle the error status appropriately (e.g., using conventional techniques). If the tunnel protocol header is successfully validated (step 516), then, in step 520, the hardware accelerator decapsulates the inbound packet returns the resulting decapsulated packet along with the Tunnel ID to the tunnel software application.

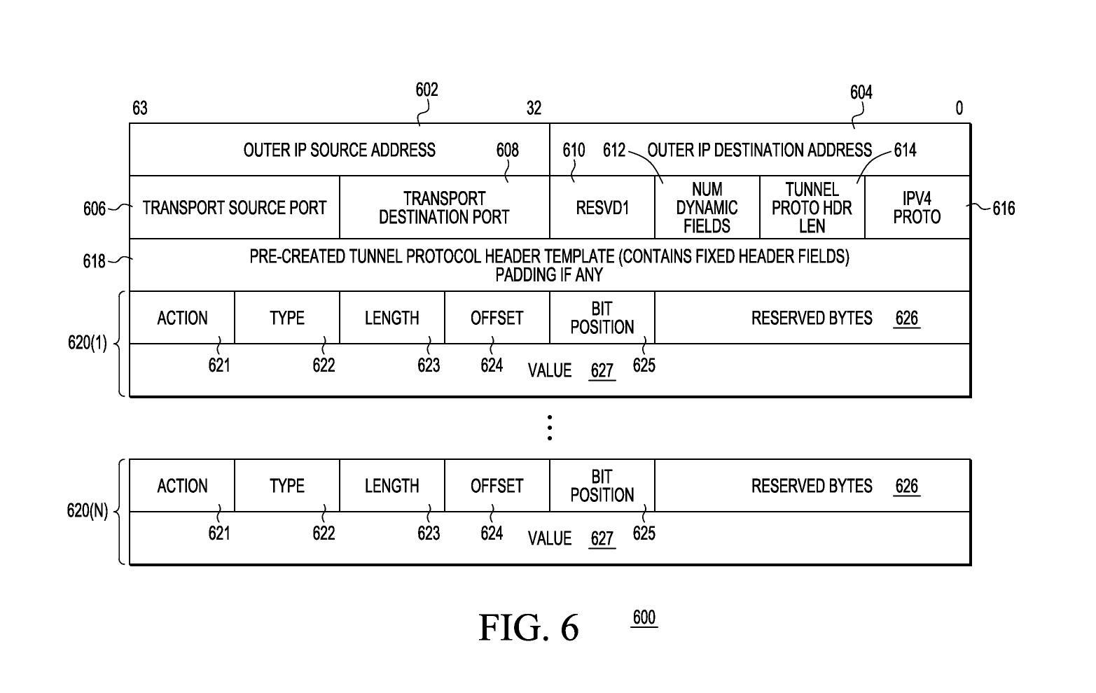

FIG. 6 represents the generic format for the outbound profiles 600 for the different tunnel protocols supported by hardware accelerator 150 for outbound packets having outer IPv4 (Internet Protocol version 4) headers. Generic outbound profile 600 has profile fields 602-620 that represent and/or define the tunnel protocol header for each different supported tunnel protocol. For a particular communications session between two nodes using a particular tunnel protocol over a particular communications network, tunnel software application 140 in each node generates the appropriate outbound profile as a particular instance of generic outbound profile 600 (e.g., in step 202 of FIG. 2) and provides that specific instance of outbound profile 600 to hardware accelerator (e.g., in step 204).

In particular, every instance of outbound profile 600 has the following nine profile fields 602-618:
4-byte Outer IP Source Address field 602: IP address of the transmitting node;
4-byte Outer IP Destination Address field 604: IP address of the receiving node;
2-byte Transport Source Port field 606: ID number of the transport port on the transmitting node at which the outbound packet will appear;
2-byte Transport Destination Port field 608: ID number of the transport port on the receiving node to which the outbound packet will be applied;
1-byte reserved field 610;
1-byte Number Dynamic Fields field 612: Number of dynamic fields in the outbound profile;
1-byte Tunnel Protocol Header Length field 614: Size (in bytes) of the tunnel protocol header;
1-byte IP Protocol field 616: Transport protocol, such as UDP or TCP; and
Header Template field 618: Pre-created tunnel protocol header template with one or more fixed header fields. The length of Header Template field 618 in bytes is specified by the value of field 614.
   These nine profile fields provide information for the outer, transport header(s). The values of these nine profile fields will be the same for all packets transmitted from the specified source to the specified destination during a particular communications session (i.e., one tunnel stream).

In addition, depending on the particular tunnel protocol, the outbound profile might define one or more dynamic tunnel protocol header fields (i.e., header fields in which the value may change from packet to packet during a given communications session). The number of dynamic tunnel protocol header fields (i.e., zero, one, or more) is specified in profile field 612. If profile field 612 contains a non-zero value N, then profile field 618 will be followed by N profile fields 620, where each 16-byte profile field 620(i) defines a different dynamic tunnel protocol header field using the following profile sub-fields:
1-byte Action sub-field 621: There are different types of dynamic tunnel protocol header fields for which the hardware accelerator needs to perform one of three different types of action: Protocol-Length, Sequence, and Software. A Protocol-Length action means that the value for the dynamic tunnel protocol header field is to be the sum of (i) the value in the Tunnel Protocol Header Length field 614 and (ii) the size (in bytes) of packet's payload as calculated by the hardware accelerator. A Sequence action means that the value for the dynamic tunnel protocol header field is to be incremented for every packet in the particular communications session. A Software action means that the value for the dynamic tunnel protocol header field will be provided by tunnel software application 140 when the packet is provided to the hardware accelerator (e.g., in step 402 of FIG. 4).
1-byte Value sub-field 622: See below.
Type sub-field 623: See below.
Length sub-field 624: See below.
Bit-Position sub-field 625: See below.
Offset sub-field 626: See below.

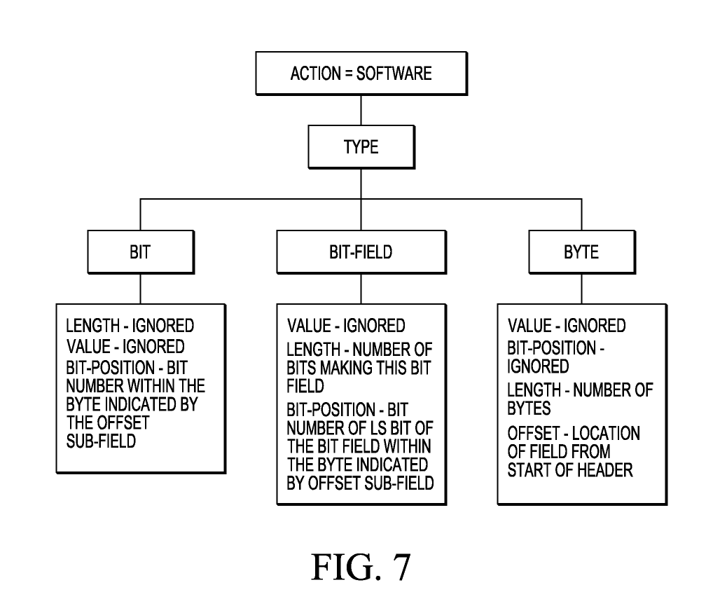

FIG. 7 is a logic flow diagram describing the meanings of the Type, Length, Offset, Bit Position, and Value sub-fields when Action sub-field 621 indicates that the hardware accelerator needs to perform a Software action for the corresponding dynamic field. In that case, Value sub-field 627 is ignored, and Type sub-field 622 can be any of Bit, Bit-Field, or Byte.

When Type=Bit, the dynamic tunnel protocol header field is a single bit (i.e., a single-bit field) in the tunnel protocol header, Length sub-field 623 is ignored, and Bit Position sub-field 625 indicates the position of the single-bit field within the byte at the location specified by the Offset sub-field 624 from the start of tunnel protocol header.

When Type=Bit-Field, the dynamic tunnel protocol header field is two or more bits long (i.e., a multi-bit field), Length sub-field 623 indicates the number of bits forming the multi-bit field, and Bit Position sub-field 625 represents the position of the least-significant bit (LSB) of the multi-bit field, within the byte at the location specified by the Offset sub-field 624.

When Type=Byte, the dynamic tunnel protocol header field is one or more bytes long, Bit Position sub-field 625 is ignored, Length sub-field 623 indicates the length of this field in bytes. The Offset sub-field 624 indicates the location of this field from the start of tunnel protocol header.

Value sub-field 627 is ignored for Software actions, because the value may change for each outbound packet. Instead, the value is supplied by the tunnel software application along with the outbound packet to the hardware accelerator. There can be many ways to supply the value to the hardware accelerator, such as by writing the value into a memory location or a register that the hardware accelerator can access.

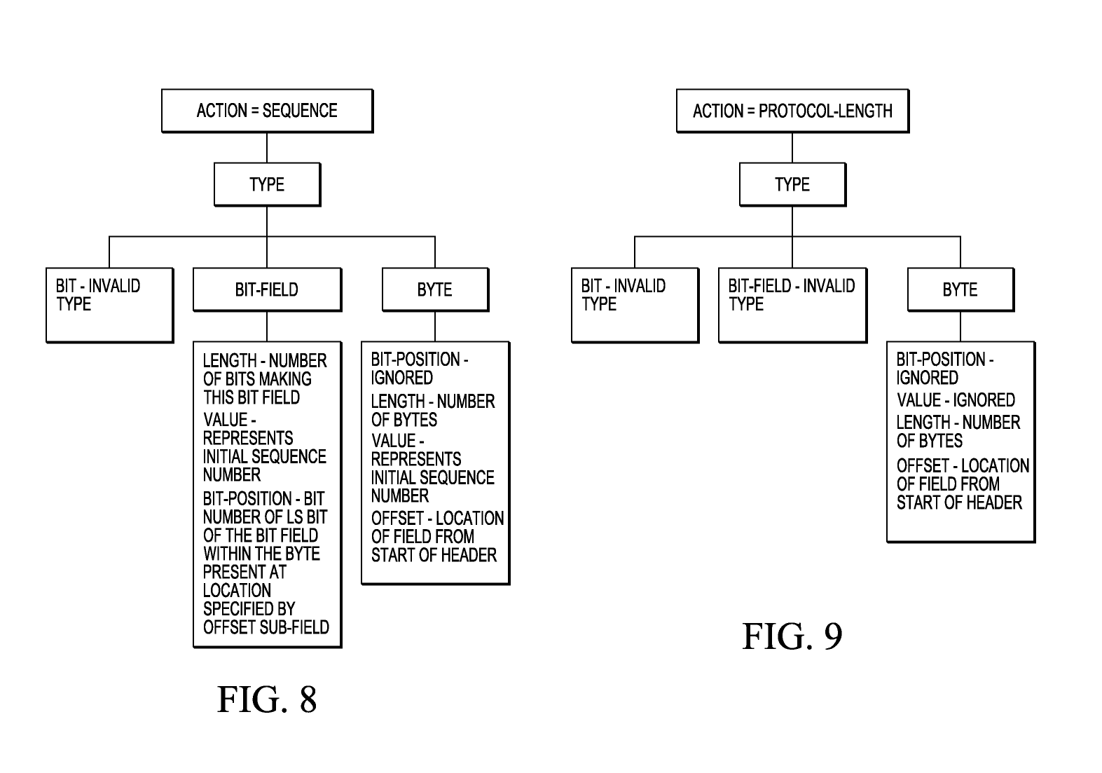

FIG. 8 is a logic flow diagram describing the meanings of the Type, Length, Offset, Bit Position, and Value sub-fields when Action sub-field 621 indicates that the hardware accelerator needs to perform a Sequence action for the corresponding dynamic field. In that case, Type sub-field 622 can be any of Bit-Field or Byte.

When Type=Bit-Field, Length sub-field 623 is the number of bits in this bit field, Value sub-field 627 is the initial sequence number, and Bit Position sub-field 625 indicates the LSB within the byte indicated by Offset sub-field 624.

When Type=Byte, Bit Position sub-field 625 is ignored, Length sub-field 623 is the number of bytes of this byte field, Value sub-field 627 is the initial sequence number, and Offset sub-field 624 indicates the starting location of this field from tunnel protocol header.

FIG. 9 is a logic flow diagram describing the meanings of the Type, Length, Offset, Bit Position, and Value sub-fields when Action sub-field 621 indicates that the hardware accelerator needs to perform a Protocol-Length action for the corresponding dynamic field. In that case, Bit Position sub-field 625 and Value sub-field 627 are ignored, Type sub-field 622 can be only Byte, Length sub-field 623 is the number of bytes in this byte field, and Offset sub-field 624 indicates the starting location of this field from tunnel protocol header.

As indicated previously, depending on the particular tunnel protocol, the tunnel protocol header might also have one or more fixed tunnel protocol header fields (i.e., header fields in which the value will be the same for all packets for a given tunnel protocol independent of the particular communications session). If so, then those fixed tunnel protocol header fields are specified as part of a pre-created tunnel protocol header template in Header Template field 618. Although most tunnel protocols have some fixed header fields, the present invention works even for tunnel protocols that do not have any fixed fields. In that case, the pre-created tunnel header template will have all zeros in it, and each dynamic field of the tunnel protocol header will be specified in the dynamic fields section of the profile.

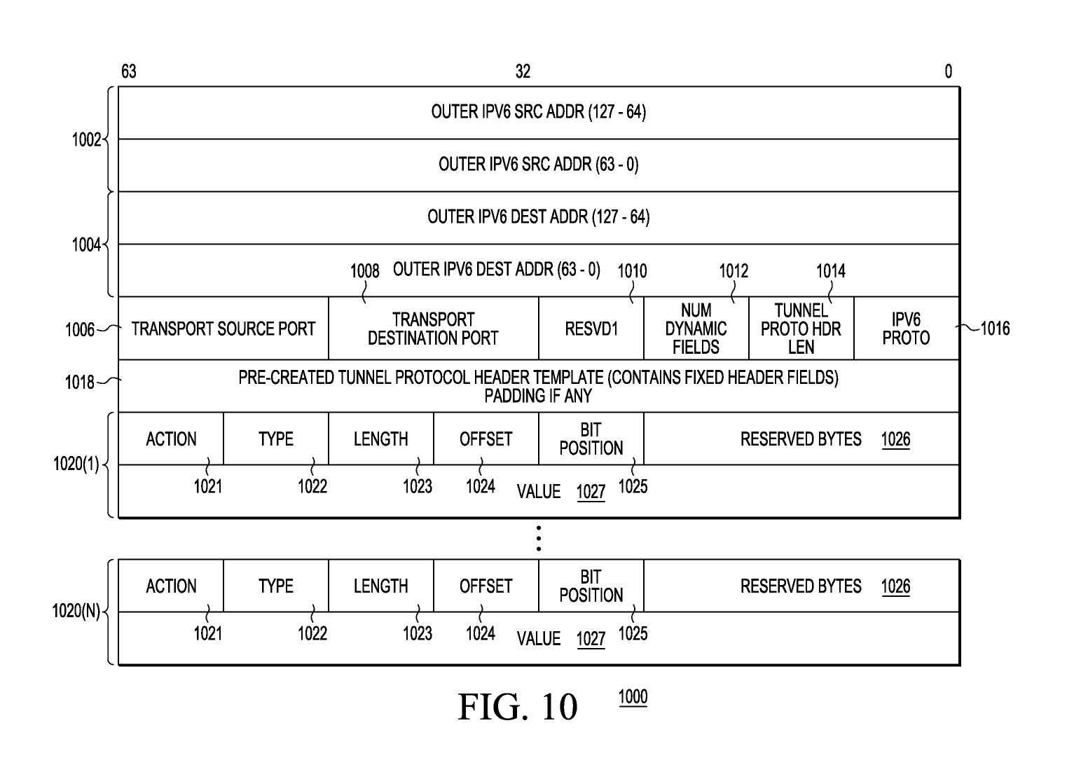

FIG. 10 represents the generic format for the outbound profiles 1000 for the different tunnel protocols supported by hardware accelerator 150 for outbound packets having outer IPv6 (Internet Protocol version 6) headers. IPv6 outbound profile 1000 is identical to IPv4 outbound profile 600 of FIG. 6, with analogous fields and sub-fields having analogous labels, except that Outer IP Source Address field 1002 and Outer IP Destination Address field 1004 of IPv6 outbound profile 1000 are 16 bytes each, while Outer IP Source Address field 602 and Outer IP Destination Address field 604 of IPv4 outbound profile 600 are only 4 bytes each.

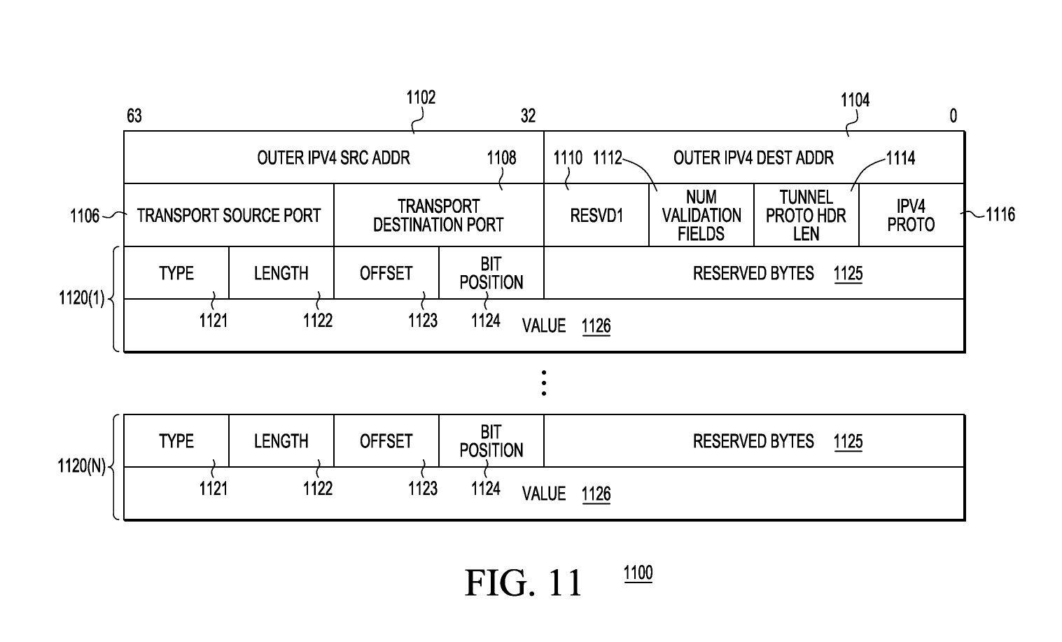

FIG. 11 represents the generic format for the inbound profiles 1100 for the different tunnel protocols supported by hardware accelerator 150 for inbound packets having outer IPv4 headers. Generic inbound profile 1100 has profile fields 1102-1120 that represent and/or define the tunnel protocol header for each different supported tunnel protocol. For a particular communications session, tunnel software application 140 in each node generates the appropriate inbound profile as a particular instance of generic inbound profile 1100 (e.g., in step 202 of FIG. 2) and provides that specific instance of inbound profile 1100 to hardware accelerator (e.g., in step 204).

In particular, every inbound profile has the following eight profile fields 1102-1116:
4-byte Outer IP Source Address field 1102: IP address of the transmitting node;
4-byte Outer IP Destination Address field 1104: IP address of the receiving node;
2-byte Transport Source Port field 1106: ID number of the transport port on the transmitting node at which the outbound packet will appear;
2-byte Transport Destination Port field 1108: ID number of the transport port on the receiving node to which the outbound packet will be applied;
1-byte reserved field 1110;
1-byte Number Validation Fields field 1112: Number of validation fields in the inbound profile;
1-byte Tunnel Protocol Header Length field 1114: Size (in bytes) of the tunnel protocol header; and
1-byte IP Protocol field 1116: Transport protocol, such as UDP.
   These eight profile fields identify information in the outer, transport header(s). The values of these eight profile fields will be the same for all packets transmitted during a particular communications session. Note that, for a given communications session, the values for the source address and port for the inbound profile of FIG. 11 will be equal to the values for the destination address and port for the outbound profile of FIG. 6, and vice versa.

In addition to profile fields 1102-1116, inbound profile 1100 also has Validation fields 1120 that identify and characterize one or more tunnel protocol header fields that are to be used to validate the inner, tunnel protocol header of the inbound packet. As indicated previously, profile field 1112 identifies the number N of different tunnel protocol header fields to be used for validation, where profile field 1116 will be followed by N Validation fields 1120, where each Validation field 1120(i) defines a different tunnel protocol header field to be used for validation by the following profile sub-fields:
1-byte Type sub-field 1121: The value stored in this sub-field represents either Bit, Byte, or Bit-Field.
1-byte Length sub-field 1122: See below.
1-byte Offset sub-field 1123: See below.
1-byte Bit-Position sub-field 1124: See below.
4-byte reserved field 1125.
8-byte Value sub-field 1126: See below.

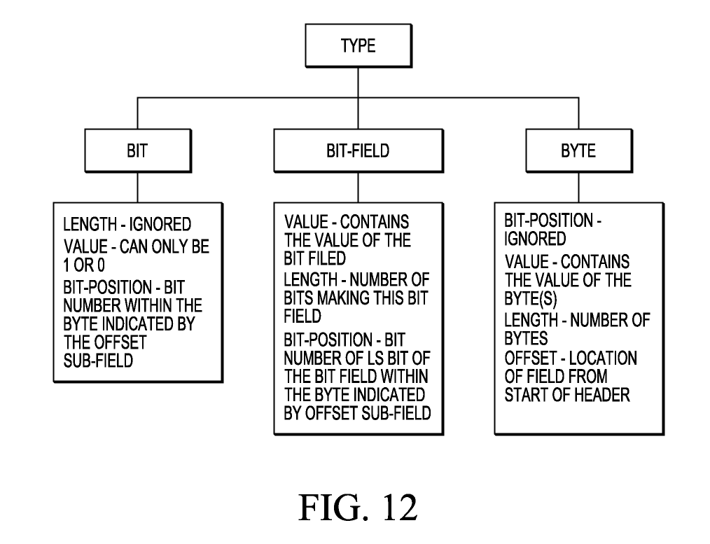

FIG. 12 is a logic flow diagram describing the meanings of the Type, Length, Offset, Bit Position, and Value sub-fields of each Validation field 1120(i), where Type sub-field 1121 can be any of Bit, Bit-Field, or Byte.

If the Type sub-field 1121 is Bit, then the tunnel protocol header field to be validated is a single-bit field, the Length sub-field 1122 is ignored, and the Bit-Position sub-field 1124 indicates the position of the bit within the byte at the location specified by the Offset sub-field 1123 from the start of tunnel protocol header. The expected value of this single-bit field is given by the Value sub-field 1126, which can be either 1 or 0.

If the Type sub-field 1121 is Bit-Field, then the tunnel protocol header field to be validated is a multi-bit field. The Length sub-field 1122 gives the number of bits to be considered, and the Bit-Position sub-field 1124 gives the position of the LSB of the multi-bit field within the byte located at the offset indicated by the Offset sub-field 1123. The expected value of this multi-bit field is given by the Value sub-field 1126.

If the Type sub-field 1121 is Byte, then the tunnel protocol header field to be validated is interpreted in terms of bytes, the Length sub-field 1122 represents the number of bytes that make up the tunnel protocol header field, which is located at the offset indicated by the Offset sub-field 1123. The expected value of this tunnel protocol header field is given by the Value sub-field 1126. The Bit-Position sub-field 1124 is ignored.

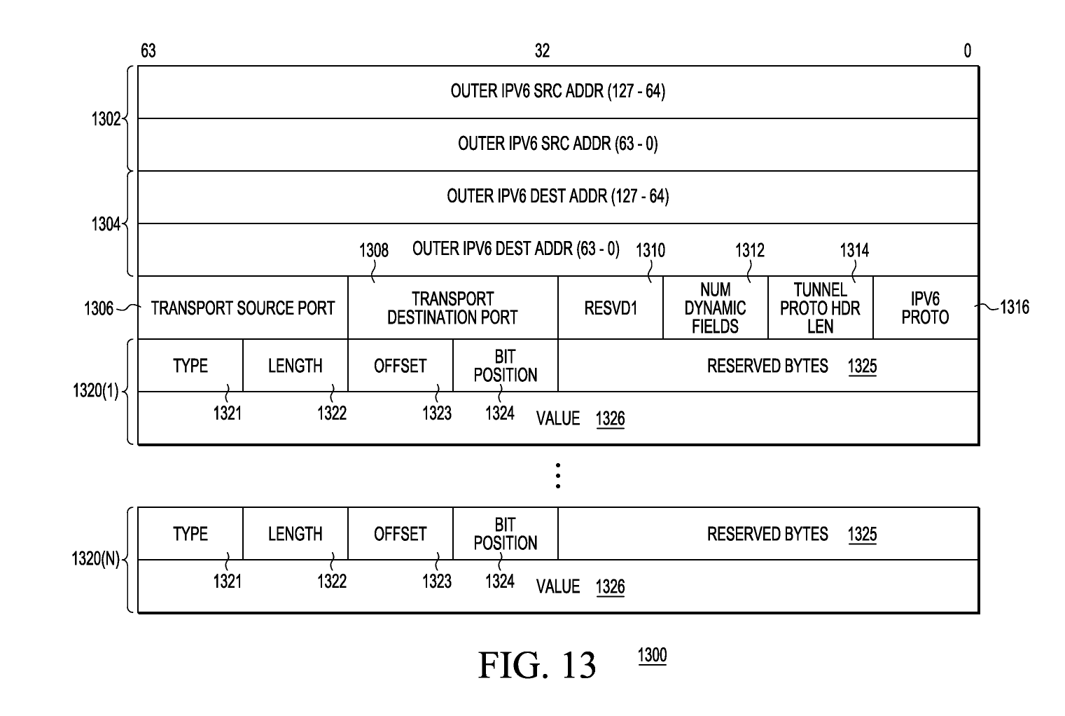

FIG. 13 represents the generic format for the inbound profiles 1300 for the different tunnel protocols supported by hardware accelerator 150 for inbound packets having outer IPv6 headers. IPv6 inbound profile 1300 is identical to IPv4 inbound profile 1100 of FIG. 11, with analogous fields and sub-fields having analogous labels, except that Outer IP Source Address field 1302 and Outer IP Destination Address field 1304 of IPv6 inbound profile 1300 are 16 bytes each, while Outer IP Source Address field 1102 and Outer IP Destination Address field 1104 of IPv4 inbound profile 1100 are only 4 bytes each.

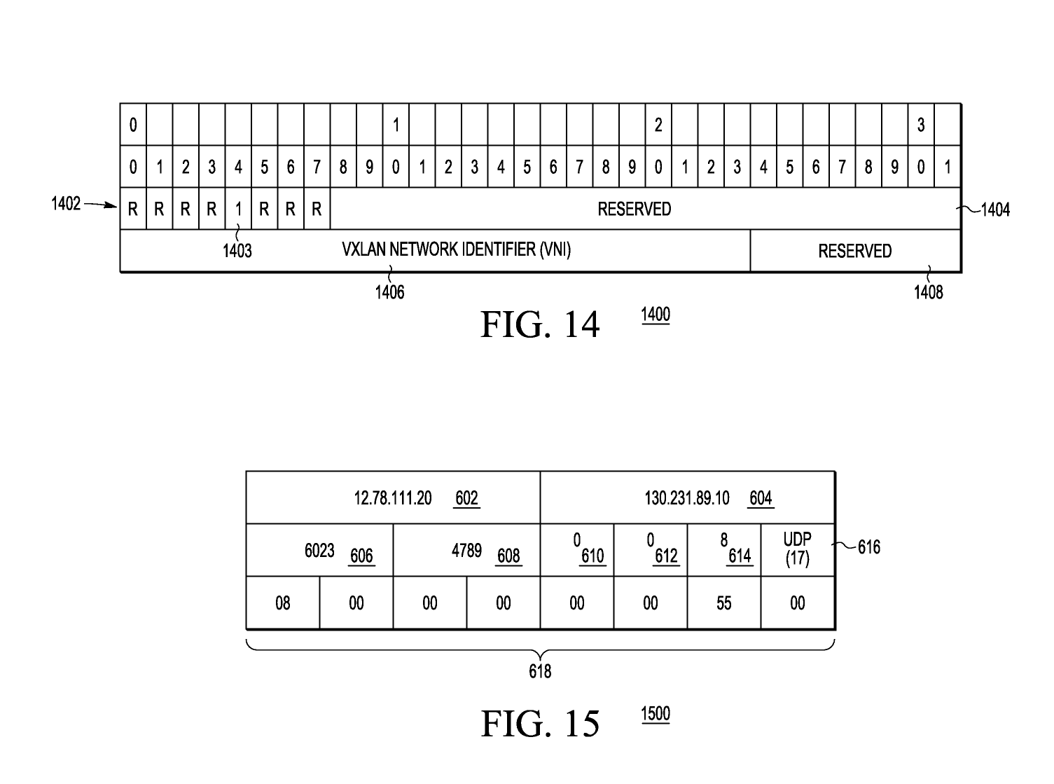

FIG. 14 shows a representation of the format of the tunnel protocol header 1400 according to the VX-LAN tunnel protocol. As shown in FIG. 14, the 8-byte VX-LAN tunnel protocol header 1400 comprises:
A 1-byte field 1402 in which the fourth bit 1403 is a “1” and the other seven bits are reserved;
Followed by a 3-byte reserved field 1404;
Followed by a 3-byte VX-LAN Network Identifier (VNI) field 1406; and
Followed by a 1-byte reserved field 1408.

Assume, for example, that an IPv4 communications session is to be established between (i) node 110 of FIG. 1 having IP address 12.78.111.20 using UDP port 6023 and (ii) node 130 having IP address 130.231.89.10 using UDP port 4789 over communications network 120 using the VX-LAN tunnel protocol with a VNI of hexadecimal 0x00000055. In that case, tunnel software application 140 of each node will generate outbound and inbound profiles to be stored into its hardware accelerator 150 for use in the real-time encapsulation and decapsulation of outbound and inbound packets.

FIG. 15 shows a representation of the outbound profile 1500 generated by tunnel software application 140 of node 110 for this exemplary IPv4 communications session as a particular instance of the generic outbound profile 600 of FIG. 6. Note that, since the VX-LAN tunnel protocol has no dynamic fields in its tunnel protocol header, profile field 612 contains a 0. As such, hardware accelerator 150 will just copy the 8-byte pre-created tunnel protocol header shown in profile field 618 as the inner, tunnel protocol header for each outbound packet.

Note that the outbound profile generated by tunnel software application 140 of node 130 would be identical to outbound profile 1500 of FIG. 15 except that (i) the values of the outer IP source and destination addresses in profile fields 602 and 604 would be swapped and (ii) the values of the transport source and destination ports in profile fields 606 and 608 would also be swapped.

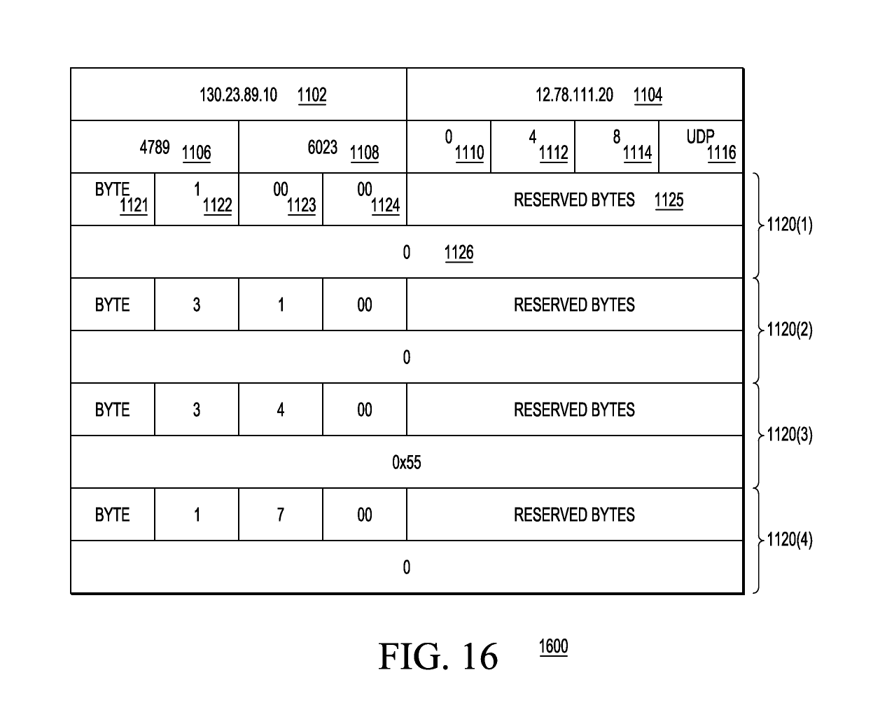

FIG. 16 shows a representation of the inbound profile 1600 generated by tunnel software application 140 of node 130 for this same exemplary communications session as a particular instance of the generic inbound profile 1100 of FIG. 11. Note that, since the VX-LAN tunnel protocol has four validation fields, profile field 1112 of FIG. 16 contains a 4, and there are four profile fields 1120(1)-1120(4), where:
Profile field 1120(1) of FIG. 16 defines 1-byte Reserved field 1402 of the VX-LAN tunnel protocol header 1400 of FIG. 14;
Profile field 1120(2) of FIG. 16 defines 3-byte Reserved field 1404 of the VX-LAN tunnel protocol header 1400 of FIG. 14;
Profile field 1120(3) of FIG. 16 defines 3-byte VNI field 1406 of the VX-LAN tunnel protocol header 1400 of FIG. 14; and
Profile field 1120(4) of FIG. 16 defines 1-byte Reserved field 1408 of the VX-LAN tunnel protocol header 1400 of FIG. 14.

Note that the inbound profile generated by tunnel software application 140 of node 110 would be identical to inbound profile 1600 of FIG. 16 except that (i) the values of the outer IP source and destination addresses in profile fields 1102 and 1104 would be swapped and (ii) the values of the transport source and destination ports in profile fields 1106 and 1108 would also be swapped.

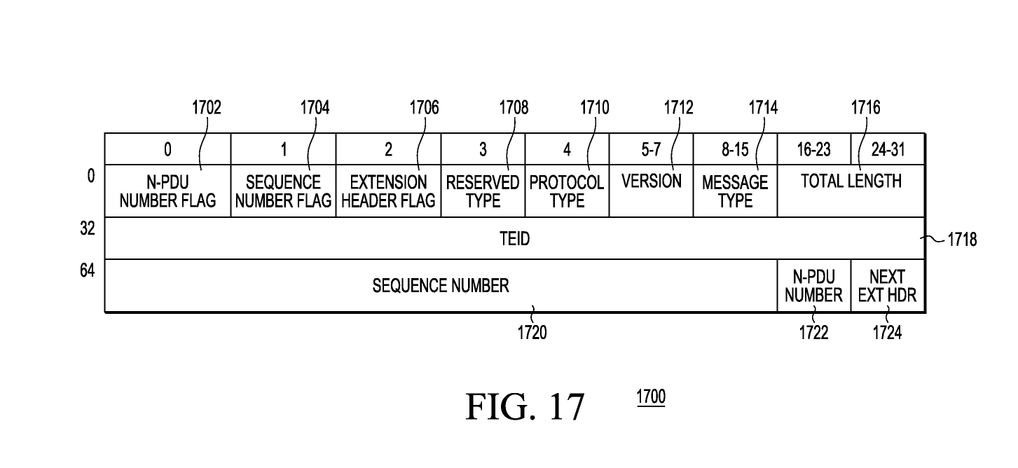

FIG. 17 shows a representation of the format of the tunnel protocol header 1700 according to the GTP-u V1 tunnel protocol. As shown in FIG. 17, the 12-byte GTP-u V1 tunnel protocol header 1700 comprises:
A 1-bit field 1702 containing the N-PDU Number Flag;
Followed by a 1-bit field 1704 containing the Sequence Number Flag;
Followed by a 1-bit field 1706 containing the Extension Header Flag;
Followed by a 1-bit field 1708 containing the Reserved Type;
Followed by a 1-bit field 1710 containing the Protocol Type;
Followed by a 3-bit field 1712 containing the Version;
Followed by a 1-byte field 1714 containing the Message Type;
Followed by a 2-byte field 1716 containing the Total Length;
Followed by a 4-byte field 1718 containing the TEID value;
Followed by a 2-byte field 1720 containing the Sequence Number;
Followed by a 1-byte field 1722 containing the N-PDU Number; and
Followed by a 1-byte field 1724 containing the Next Extension Header value.

Assume, for example, that an IPv4 communications session is to be established between node 110 of FIG. 1 having IP address 12.78.111.20 using UDP port 6023 and node 130 having IP address 130.231.89.10 using UDP port 2152 over communications network 120 using the GTP-u V1 tunnel protocol with a TEID of hexadecimal 0x00000075. In that case, tunnel software application 140 of each node will generate outbound and inbound profiles to be stored into its hardware accelerator 150 for use in real-time encapsulation and decapsulation of outbound and inbound packets.

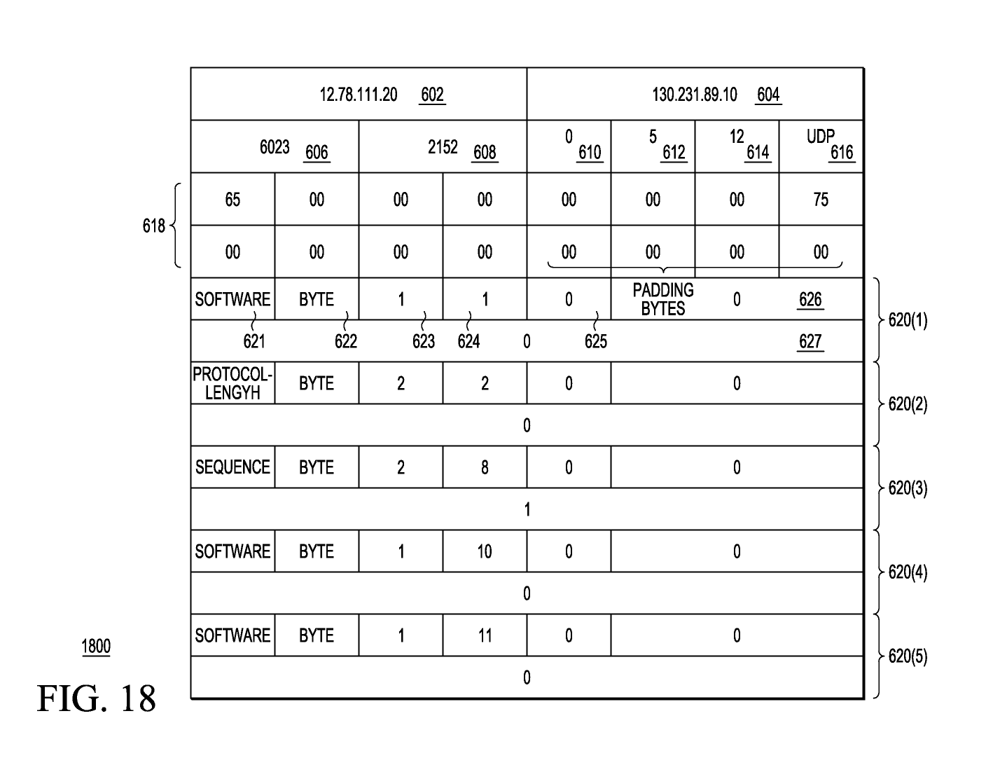

FIG. 18 shows a representation of the outbound profile 1800 generated by tunnel software application 140 of node 110 for this exemplary IPv4 communications session as a particular instance of the generic outbound format 600 of FIG. 6. Note that, since the GTP-u V1 tunnel protocol has five dynamic fields in its tunnel protocol header, profile field 612 contains a 5, and there are five profile fields 620(1)-620(5), where:
Profile field 620(1) of FIG. 18 defines the 1-byte Message Type field 1714 of the GTP-u V1 tunnel protocol header 1700 of FIG. 17;
Profile field 620(2) of FIG. 18 defines the 2-byte Total Length field 1716 of the GTP-u V1 tunnel protocol header 1700 of FIG. 17;
Profile field 620(3) of FIG. 18 defines the 2-byte Sequence Number field 1720 of the GTP-u V1 tunnel protocol header 1700 of FIG. 17;
Profile field 620(4) of FIG. 18 defines the 1-byte N-PDU Number field 1722 of the GTP-u V1 tunnel protocol header 1700 of FIG. 17; and
Profile field 620(5) of FIG. 18 defines the 1-byte Next Extension Header field 1724 of the GTP-u V1 tunnel protocol header 1700 of FIG. 17.

Profile field 618 contains the pre-created header template for the 12-byte GTP-u V1 tunnel protocol plus another 4 bytes of padding (Bytes 13-16), where Bytes 1 and 5-8 are fixed tunnel protocol header fields, and Bytes 2-4 and 9-12 correspond to the five dynamic tunnel protocol header fields. Note that the hexadecimal value 0x65 in Byte 1 of profile field 618 represents the values of fields 1702-1712 of the GTP-u V1 tunnel protocol header 1700 of FIG. 17 for the exemplary communications session.

Note that the outbound profile generated by tunnel software application 140 of node 130 would be identical to outbound profile 1800 of FIG. 18 except that (i) the values of the outer IP source and destination addresses in profile fields 602 and 604 would be swapped and (ii) the values of the transport source and destination ports in profile fields 606 and 608 would also be swapped.

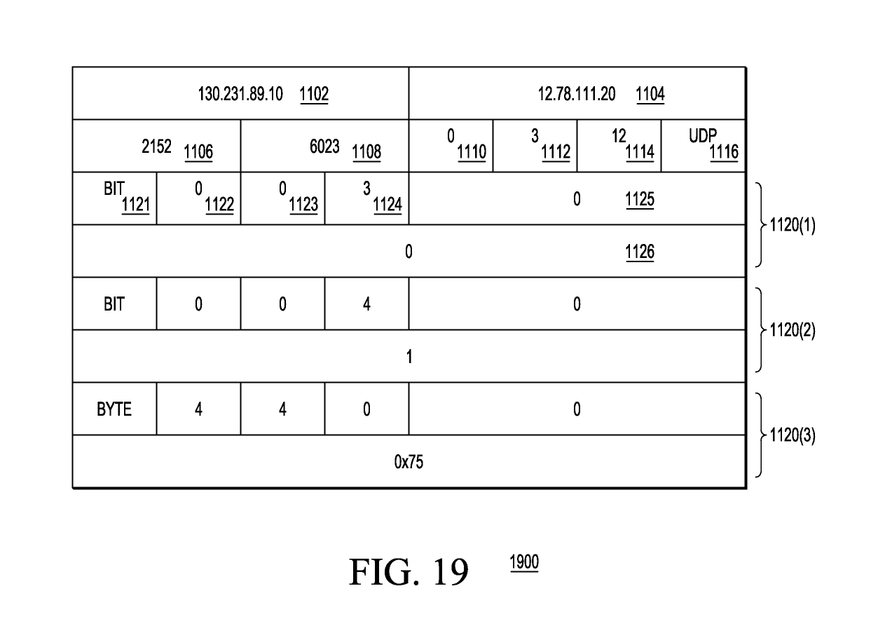

FIG. 19 shows a representation of the inbound profile 1900 generated by tunnel software application 140 of node 130 for this same IPv4 exemplary communications session as a particular instance of the generic inbound format 1100 of FIG. 11. Note that, since the GTP-u V1 tunnel protocol has three validation fields, profile field 1112 of FIG. 19 contains a 3, and there are three profile fields 1120(1)-1120(3), where:
Profile field 1120(1) of FIG. 19 defines 1-bit Reserved field 1708 of the GTP-u V1 tunnel header 1700 of FIG. 17;
Profile field 1120(2) of FIG. 19 defines 1-bit Protocol Type field 1710 of the GTP-u V1 tunnel header 1700 of FIG. 17; and
Profile field 1120(3) of FIG. 19 defines 4-byte TEID field 1718 of the GTP-u V1 tunnel header 1700 of FIG. 17.

Note that the inbound profile generated by tunnel software application 140 of node 110 would be identical to inbound profile 1900 of FIG. 19 except that (i) the values of the outer IP source and destination addresses in profile fields 1102 and 1104 would be swapped and (ii) the values of the transport source and destination ports in profile fields 1106 and 1108 would also be swapped.

Those skilled in the art will understand how to extend the generic outbound and inbound profiles 600 and 1100 of FIGS. 6 and 11 for other suitable tunnel protocols.

In some implementations of the present invention, each node is capable of simultaneously supporting two or more different, concurrent communications sessions conforming to two or more different tunnel protocols identified using two or more different Tunnel ID values.

Unless stated otherwise, terms such as “first” and “second” are used to arbitrarily distinguish between the elements such terms describe. Thus, these terms are not necessarily intended to indicate temporal or other prioritization of such elements. Further, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

Although the invention is described herein with reference to specific embodiments, various modifications and changes can be made without departing from the scope of the present invention as set forth in the claims below. Accordingly, the specification and figures are to be regarded in an illustrative rather than a restrictive sense, and all such modifications are intended to be included within the scope of the present invention. Any benefits, advantages, or solutions to problems that are described herein with regard to specific embodiments are not intended to be construed as a critical, required, or essential feature or element of any or all the claims.

1. A first node, comprising:
a hardware accelerator configurable to support any of a plurality of different tunnel protocols; and
a tunnel software application programmed to configure the hardware accelerator to support communications sessions for any of the plurality of tunnel protocols using specific outbound and inbound profiles corresponding to generic outbound and inbound profiles that respectively define encapsulation and decapsulation processing implemented by the hardware accelerator for a specific communications session.

2. The first node of claim 1, wherein, to support a first communications session with a second node over a first communications network conforming to a first tunnel protocol:
the tunnel software application provides, to the hardware accelerator, (i) a first specific outbound profile corresponding to the generic outbound profile and (ii) a first specific inbound profile corresponding to the generic inbound profile; and
the hardware accelerator provides, to the tunnel software application, a first tunnel ID value corresponding to the first communications session.

3. The first node of claim 2, wherein:
for each outbound packet of the first communications session:
the tunnel software application provides the outbound packet and the first tunnel ID value to the hardware accelerator;
the hardware accelerator uses the first tunnel ID value to identify the first specific outbound profile;
the hardware accelerator encapsulates the outbound packet according to the first specific outbound profile to generate an encapsulated outbound packet; and
the hardware accelerator provides the encapsulated outbound packet to the tunnel software application for transmission to the second node over the first communications network; and
for each inbound packet of the first communications session:
the hardware accelerator analyzes the inbound packet to determine that the first specific inbound profile applies to the inbound packet;
the hardware accelerator uses the first specific inbound profile to determine that the inbound packet's tunnel protocol header is valid;
the hardware accelerator decapsulates the inbound packet to form a decapsulated inbound packet; and
the hardware accelerator provides the decapsulated inbound packet to the tunnel software application.

4. The first node of claim 2, wherein, to support a second communications session with a third node over a second communications network conforming to a second tunnel protocol different from the first tunnel protocol:
the tunnel software application provides, to the hardware accelerator, (i) a second specific outbound profile corresponding to the generic outbound profile and (ii) a second specific inbound profile corresponding to the generic inbound profile, wherein the second specific outbound and inbound profiles are different from the first specific outbound and inbound profiles, respectively; and
the hardware accelerator provides, to the tunnel software application, a second tunnel ID value corresponding to the second communications session.

5. The first node of claim 4, wherein the first node is capable of simultaneously supporting concurrent first and second communications sessions.

6. The first node of claim 2, wherein the hardware accelerator stores the first tunnel ID value with the first specific outbound and inbound profiles.

7. The first node of claim 2, wherein, for each outbound packet of the first communications session, the hardware accelerator creates (i) one or more outer transport headers for the outbound packet and (ii) an inner tunnel header for the outbound packet.

8. The first node of claim 7, wherein:
the inner tunnel header comprises zero, one, or more dynamic header fields whose values may differ for different outbound packets in the first communications session; and
the first specific outbound profile comprises a definition for each of the zero, one, or more dynamic header fields.

9. The first node of claim 9, wherein a dynamic header field may be any of a length field, a sequence field, and a software field, wherein:
a length field corresponds to a field in the inner tunnel header for the outbound packet representing length of the encapsulated outbound packet, wherein the hardware accelerator generates a value for the length field of the inner tunnel header for the outbound packet;
a sequence field corresponds to a field in the inner tunnel header for the outbound packet representing a sequence number for the encapsulated outbound packet, wherein the hardware accelerator generates a value for the sequence field of the inner tunnel header for the outbound packet; and
a software field corresponds to a field in the inner tunnel header for the outbound packet representing a value provided to the hardware accelerator by the tunnel software application, wherein the hardware accelerator uses the value provided by the tunnel software application for the software field of the inner tunnel header for the outbound packet.

10. The first node of claim 9, wherein:
the inner tunnel header comprises:
zero or one length field;
zero or one sequence field; and
zero, one, or more software fields; and
the first specific outbound profile identifies a number of dynamic fields in the inner tunnel header of each outbound packet of the first communications session.

11. The first node of claim 2, wherein the first specific outbound profile comprises a pre-created tunnel protocol header template comprising one or more fixed header fields for the first tunnel protocol.

12. The first node of claim 2, wherein the first specific outbound and inbound profiles both comprise an outer IP source address field, an outer IP destination address field, an IP protocol field, a transport source port field, a transport destination port field, and a tunnel protocol header length field.

13. The first node of claim 2, wherein:
each inbound packet of the first communications session comprises one or more outer transport headers and an inner tunnel header;
the hardware accelerator validates the one or more transport headers of the inbound packet;
the hardware accelerator identifies the first tunnel ID value based on the validated one or more transport headers;
the hardware accelerator identifies the first specific inbound profile based on the first tunnel ID value; and
the hardware accelerator validates the inner tunnel header of the inbound packet based on the first specific inbound profile.

14. The first node of claim 13, wherein:
the first specific inbound profile comprises one or more validation fields;
each validation field identifies a fixed value in the inner tunnel header of each inbound packet of the first communications session; and
for each validation field in the first specific inbound profile, the hardware accelerator validates that the inner tunnel header of the inbound packet has the corresponding fixed value.

15. The first node of claim 1, wherein the generic outbound profile comprises:
a first outbound profile field for identifying an outer IP source address for a communications session;
a second outbound profile field for identifying an outer IP destination address for the communications session;
a third outbound profile field for identifying an IP protocol for the communications session;
a fourth outbound profile field for identifying a transport source port for the communications session;
a fifth outbound profile field for identifying a transport destination port for the communications session;
a sixth outbound profile field for identifying a tunnel protocol header length for the communications session;
a seventh outbound profile field for identifying a non-negative integer number N of dynamic tunnel protocol header fields for the communications session;
N outbound profile action fields for identifying each of the N dynamic tunnel protocol header fields for the communications session; and
an eighth outbound profile field for identifying a tunnel protocol header template for the communications session.

16. The first node of claim 15, wherein each outbound profile action field comprises:
a first outbound profile action sub-field for identifying an action for the corresponding dynamic tunnel protocol header field for the communications system;
a second outbound profile action sub-field for identifying a value for the corresponding dynamic tunnel protocol header field for the communications system;
a third outbound profile action sub-field for identifying a type for the corresponding dynamic tunnel protocol header field for the communications system;
a fourth outbound profile action sub-field for identifying a length for the corresponding dynamic tunnel protocol header field for the communications system;
a fifth outbound profile action sub-field for identifying a bit-position for the corresponding dynamic tunnel protocol header field for the communications system; and
a sixth outbound profile action sub-field for identifying an offset for the corresponding dynamic tunnel protocol header field for the communications system.

17. The first node of claim 1, wherein the generic inbound profile comprises:
a first inbound profile field for identifying an outer IP source address for the communications session;
a second inbound profile field for identifying an outer IP destination address for the communications session;
a third inbound profile field for identifying an IP protocol for the communications session;
a fourth inbound profile field for identifying a transport source port for the communications session;
a fifth inbound profile field for identifying a transport destination port for the communications session;
a sixth inbound profile field for identifying a tunnel protocol header length for the communications session;
a seventh inbound profile field for identifying a non-negative integer number N of tunnel protocol header validation fields for the communications session; and
N inbound profile validation fields for identifying each of the N tunnel protocol header validation fields for the communications session.

18. The first node of claim 17, wherein each inbound profile validation field comprises:
a first inbound profile validation sub-field for identifying a type for the corresponding tunnel protocol header validation field for the communications system;
a second inbound profile validation sub-field for identifying a bit-position for the corresponding tunnel protocol header validation field for the communications system;
a third inbound profile validation sub-field for identifying a length the corresponding tunnel protocol header validation field for the communications system;
a fourth inbound profile validation sub-field for identifying a value for the corresponding tunnel protocol header validation field for the communications system; and
a fifth inbound profile validation sub-field for identifying an offset for the corresponding tunnel protocol header validation field for the communications system.
